(19) United States
(12) Patent Application Publication
(10) Pub. No.: US 2015/0161646 A1
(43) Pub. Date: Jun. 11, 2015

(54) PROVIDING ACCESS TO A CLOUD STORAGE SERVICE ACCORDING TO AN AWARDED CREDIT

(71) Applicants: Kimon Papahadjopoulos, Berkeley, CA (US); Philippe Ciampossin, Saratoga, CA (US); David Martin, Saratoga, CA (US)

(72) Inventors: Kimon Papahadjopoulos, Berkeley, CA (US); Philippe Ciampossin, Saratoga, CA (US); David Martin, Saratoga, CA (US)

(21) Appl. No.: 14/131,031

(22) PCT Filed: Aug. 10, 2011
(86) PCT No.: PCT/US2011/047210

§ 371 Date: Jan. 6, 2014

(51) Int. Cl. G06Q 30/02

(52) U.S. Cl. CPC G06Q 30/0226

(57) ABSTRACT

Credit associated with a cloud storage service is provided in response to acquisition of an offering. The cloud storage service allows storage of data over a network. The cloud storage service is accessed based on the credit.

### BACKGROUND

Consumer loyalty programs are implemented by various enterprises to encourage consumers to purchase products or services offered by the enterprises. For example, airlines award miles to their consumers in return for flying with the airlines. Product sellers may offer various types of rewards, such as discounts, for consumers to purchase products offered by the sellers.

### BRIEF DESCRIPTION OF THE DRAWINGS

Some embodiments are described with respect to the following figures:

FIG. 1 is a block diagram of an example arrangement in which some implementations can be incorporated;

FIG. 2 is a flow diagram of a loyalty program management process according to some implementations;

FIGS. 3-6 illustrate various example graphical user interface (GUI) screens relating to a consumer loyalty program according to some implementations; and

FIG. 7 is a block diagram of a system capable of incorporating some implementations.

### DETAILED DESCRIPTION

Consumer loyalty programs based on consumer purchase of products or services offered by enterprises (e.g. businesses) are typically focused on awarding free or discounted products or services offered by the enterprises (or offered by partner enterprises). Although such consumer loyalty programs have differing levels of success in enticing customers to purchase products or services from the respective enterprises, the level of participation by customers may not be as high as some enterprises may hope for.

In accordance with some implementations, a consumer loyalty program is provided to entice participation by consumers by awarding access to cloud storage services. In return for purchase of products or services, or participation in the consumer loyalty program, a consumer is given access to cloud storage services. Such access can be granted based on awarding credits in return for certain activities of the consumer—the consumer has access to cloud storage services so long as the consumer has sufficient credits.

A “cloud storage service” includes a service where a consumer is allocated storage space accessible over a network (e.g. Internet or other type of network) to store data of the consumer. This is referred to as a “basic cloud storage service”—examples of enhanced or premium cloud storage services are discussed further below. Rather than having to store data at a local electronic device of the consumer (e.g. notebook computer, desktop computer, tablet computer, personal digital assistant, local storage device, and so forth), the consumer can choose to store data in allocated storage space provided by the cloud storage service. The allocated storage space can be provided by a storage system (or multiple storage systems) accessible over the network.

By being able to store data of the consumer in the cloud storage space instead of at a local storage device, the consumer may be able to save money by not having to purchase additional storage devices or storage devices having larger capacity. Also, the consumer does not have to worry about loss of data due to failure of the consumer's storage devices, such as hard disk drives.

In addition to providing the basic cloud storage service in which a consumer can store the consumer's data in an allocated cloud storage space, techniques or systems according to some implementations also can offer enhanced or premium cloud storage services. Examples of such premium cloud storage services include data backup services (in which data of the consumer is backed up at specified intervals), shared cloud storage services (in which multiple users belonging to a group, such as a home or a business, or multiple electronic devices can access the same shared cloud storage space), an expense report generation service (also referred to as a cloud receipts service, in which an expense report can be generated based on receipts provided by the consumer), and/or other services.

Providing premium cloud storage services can increase the value to the consumer, and thus can increase the likelihood of retaining a consumer in the consumer loyalty program (and future purchases of offerings from the enterprise or from partners). Additionally, premium cloud storage services can themselves be revenue generators—in some cases, consumers may even be willing to directly pay for cloud service credits to have access to certain premium cloud storage services. The premium cloud storage services thus provide upsell opportunities to allow the enterprise to generate more revenue.

In response to certain activities of the consumer, a reward credit can be awarded to the consumer, where the reward credit can be used by the consumer to access cloud storage services. In the ensuing discussion, a credit associated with use of cloud storage services is referred to as a “cloud service credit.” A “reward credit” refers to cloud service credit awarded to a consumer based on certain predefined activities of the consumer. Activities that give rise to reward credits include purchase of offerings of an enterprise (or multiple enterprises that are part of the consumer loyalty program), where an “offering” refers to a product or service. A reward credit can also be given to the consumer in response to the consumer initially activating (joining) the loyalty program. Reward credit can also be added in response to other users joining the same loyalty program as the consumer, such that the other users and the consumer form a group. Reward credit can further be added when a consumer pools multiple electronic devices in the associated consumer loyalty program—the multiple electronic devices of the pool can access cloud storage services provided to the consumer.

In addition to awarding cloud service credits based on predefined activities of the consumer, cloud service credits can also be purchased.

As cloud storage services are used by a consumer, the cloud service credit associated with the consumer is incrementally decreased. However, such cloud service credit can be replenished in response to additional activity of the consumer (or of any consumers within a group). If the cloud service credit were to be depleted, the consumer can be given the opportunity to purchase further cloud service credit, or the consumer can be prompted to engage in any one of predefined activities to be awarded additional cloud service credit.

Awarding cloud storage services to consumers can encourage consumers to participate in an enterprise's consumer loyalty program. For example, the enterprise may sell notebook computers, tablet computers, printers, peripheral devices, consumables such as printer ink and paper, and so forth. By encouraging consumer participation in the consumer loyalty program that offers cloud storage services, consumers would be encouraged to purchase offerings from the enterprise (or partner enterprises) rather than from competing enterprises to be able to continue accessing the cloud storage services.

Cloud storage services may be a feature that many consumers value, which increases the likelihood of retaining the consumers in the consumer loyalty program. Data backup and pooling of information for access by multiple users are issues that are faced by many users—awarding cloud storage services provides an easy way for consumers to access such services without having to invest in equipment or software applications for such services. Once consumers start using cloud storage services offered by an enterprise, it may be inconvenient for the consumers to migrate their data elsewhere, which presents a barrier to consumers leaving the consumer loyalty program.

Additionally, behavior of consumers can be tracked due to participation in the consumer loyalty program. Since each purchase activity would be recorded in the consumer's loyalty program account, an enterprise would be able to easily track the purchase history of the consumer. Moreover, by encouraging pooling of electronic devices and/or grouping of multiple users in a common account, an enterprise would be able detect purchase patterns of the consumer (or group of consumers). An enterprise can thus understand which electronic devices consumers tend to purchase for use together, whether individually or in a group setting. The enterprise can also track the rate of purchase of consumables, such as ink and paper.

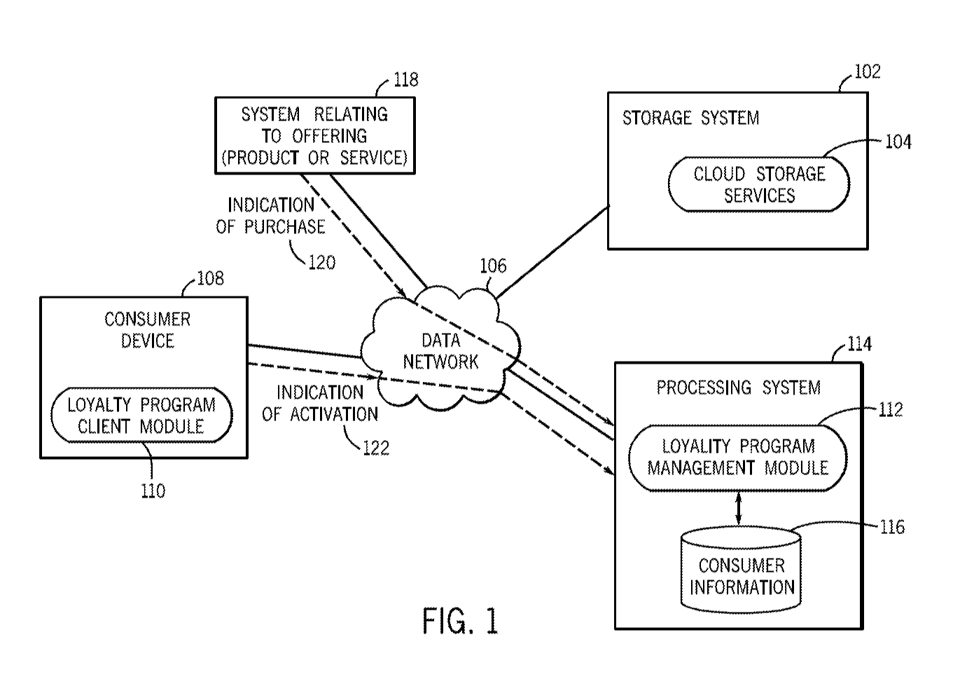

FIG. 1 is a block diagram of an example arrangement according to some implementations. A storage system 102 provides cloud storage services 104 such as those discussed above. Although just one storage system 102 is shown, note that in alternative examples, additional storage systems can be provided, such that the collection of distributed storage systems can provide cloud storage services to consumers. The storage system 102 includes storage devices, to store data, as well as applications to provide premium services (e.g. data backup services, shared cloud storage service accessible by a group of consumers, expense report generation, etc.) that may be desired by consumers.

The cloud storage services 104 of the storage system 102 are accessible by a consumer device 108 (e.g. notebook computer, desktop computer, tablet computer, personal digital assistant, a printer, or other electronic device) over a data network 106. The consumer device 108 includes a loyalty program client module 110, which is executable in the consumer device 108 to provide features of the loyalty program according to some implementations. Details regarding the loyalty program client module 110 are discussed further below.

The loyalty program client module 110 of the consumer device 108 is able to interact with a loyalty program management module 112 running in a processing system 114, which is also connected to the data network 106. The loyalty program management module 112 has access to consumer information 116, which includes identification information to identify consumers who are registered in the consumer loyalty program, information relating to credits available to each consumer for accessing the cloud storage services 104, and other information.

Also depicted in FIG. 1 is a system 118 relating to an offering of an enterprise. For example, the system 118 can be a web server that provides a website at which the consumer device 108 can purchase an offering of an enterprise. In response to such purchase, the system 118 can send an indication of the purchase (120) to the processing system 114 over the data network 106.

In alternative examples, the system 118 can be a printer device. The printer device is able to communicate over the data network 106, and the printer device can automatically provide an indication of purchase (120) in response to a consumer placing a new ink cartridge (sold by the enterprise offering the consumer loyalty program) in the printer.

In other examples, the indications of purchase (120) can be provided to the processing system 114 using other techniques. For example, a consumer at the consumer device 108 can manually enter such indication. After the consumer has purchased a product or service, the consumer can provide some identifier (such as a bar code or other identifier) associated with the purchase to the processing system 114. The processing system 114 can provide a user interface, such as a web page, to allow the user to enter such information.

The consumer device 108 can also provide an indication of activation (122) to the processing system 114 over the data network 106. When the consumer initially activates the consumer loyalty program at the consumer device 108, such indication (122) can be sent to the processing system 114.

Based on the indication of purchase 120 and/or indication of activation 122, the loyalty program management module 112 at the processing system 114 is able to update (increase) the cloud service credit that is available to the consumer in the consumer information 116.

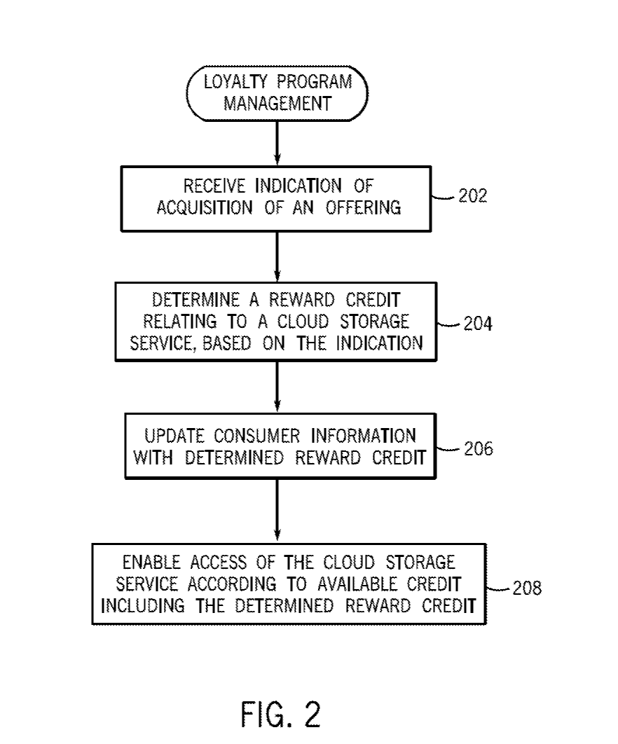

FIG. 2 is a flow diagram of a process of the loyalty program management module 112, according to some implementations. The loyalty program management module 112 receives (at 202) an indication of acquisition of an offering. This indication can be the indication of purchase (120) depicted in FIG. 1, or alternatively, the received indication can be an indication of activation (122) of a consumer loyalty program.

Based on the received indication, the loyalty program management module 112 determines (at 204) a reward credit relating to a cloud storage service to award to the consumer. For example, in return for activating the loyalty program management module 112 at the consumer device 108, the consumer is awarded a certain amount of cloud service credit. In return for purchases of various offerings, the consumer is awarded varying respective amounts of cloud service credit.

The consumer information (e.g. 116 in FIG. 1) of the consumer is then updated (at 206) with the determined reward credit, by increasing the amount of the cloud service credit associated with the consumer with the determined reward credit.

Next, the loyalty program management module 112 enables (at 208) access of the cloud storage service by the consumer according to available cloud service credit (which includes the determined reward credit). Enabling access of the cloud storage service can involve the loyalty program management module 112 sending some indication to the storage system 102 that the consumer has credit to use the cloud storage services 104—in some examples, such indication can provide an amount of the available cloud service credit. Upon receipt of such indication, the storage system 102 can allow the consumer at the consumer device 108 to access the cloud storage services 104, until the storage system 102 is notified by the loyalty program management module 112 that the consumer no longer has credit to access cloud storage services 104. Alternatively, in response to a request by the consumer device 108 for access of a cloud storage service 104, the storage system 102 can first make an inquiry with the processing system 114 to determine whether the consumer device 108 should be granted access to the cloud storage service 104. The loyalty program management module 112 can respond with an affirmative or negative indication based on the amount of cloud service credit available to the consumer device 108.

In accordance with some implementations, activation (joining) of the consumer loyalty program that awards cloud storage services is made easy to consumers. A barrier to consumers joining a consumer loyalty program is often caused by an enterprise asking for too much personal information from the consumers before the consumers are allowed to join. In some implementations, “one-click” activation is provided, where a consumer simply has to click on a button of a graphical user interface (GUI) provided by the loyalty program client module 110 (FIG. 1) to activate the consumer loyalty program. In other implementations, other relatively simple mechanisms are provided to allow consumers to join the consumer loyalty program.

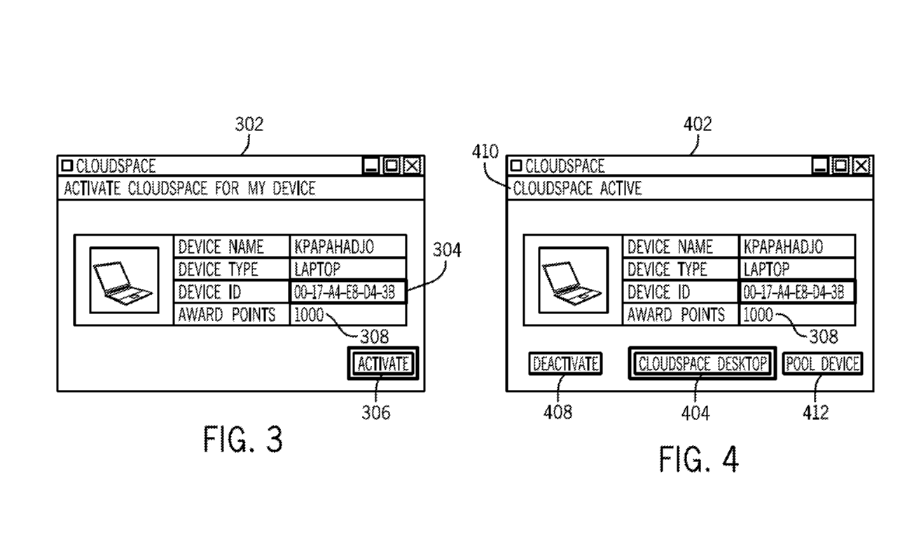

FIG. 3 depicts an example GUI screen 302 that can be presented to a consumer at the consumer device 108 for activating “CloudSpace” (which refers to the loyalty program that provides access to the cloud storage services 104 of FIG. 1).

In the ensuing discussion, reference is made to various example GUI screens (including those shown in FIGS. 3-6). Note, however, that different GUI screens can be presented to users in other examples.

In the GUI screen 302 of FIG. 3, the consumer device 108 can be identified by a device identifier 304. An Activate button 306 is provided to allow the consumer to perform one-click activation of the “CloudSpace” loyalty program. As noted above, allowing one-click activation lowers the barrier to entry and thus entices a higher percentage of consumers to join the loyalty program. In some examples, the consumer does not have to enter any personal information or create an account. This is possible because the consumer device 108 is associated with a unique identifier (e.g. 304) for identifying the consumer without the consumer having to supply any additional information. This makes signing up for the loyalty program as easy as possible.

A consumer that activates the “CloudSpace” program at the consumer device 108 is given a reward credit (which can be time-based) to use the cloud storage services 104 of FIG. 1. In the example depicted in FIG. 3, the reward credit includes 1,000 award points. The reward credit can expire after a predefined amount of time.

When the predefined amount of time expires, read access of the data in the cloud storage space can still be allowed for a certain period of time (e.g. months or years); however, write access is disabled unless additional cloud service credit is obtained by the consumer (either by paying for the additional credit or by purchasing a qualified offering). Allowing the consumer continued access to data even after cloud service credit has expired or has been depleted gives the consumer some confidence that the consumer's data will be safe and accessible even if the consumer chooses not to continue in the loyalty program. This can help alleviate any anxiety that the consumer may feel regarding inability to access the consumer's data if the consumer does not actively participate in the consumer loyalty program.

The consumer loyalty program model according to some implementations can expect some degree of consumer chum since consumers tend to use more storage space over time, and thus may not be as profitable or cost effective to the provider of the loyalty program. Thus, allowing consumers leave the loyalty program but yet retain access to the consumers' data results in increased likelihood that the remaining consumers are more profitable to the provider.

In response to user clicking of the Activate button 306, another example GUI screen 402 as shown in FIG. 4 is displayed. The GUI screen 402 includes an indication 410 that the CloudSpace loyalty program is active. In addition, the GUI screen 402 includes a CloudSpace Desktop button 404 to allow the consumer to access a desktop GUI screen for accessing cloud storage services 104 (FIG. 1). The GUI screen 402 also shows the balance of cloud service credit (308) remaining for the consumer to access the cloud storage services. Also, a Deactivate button 408 can be provided in the GUI screen 402 to allow the user to deactivate the CloudSpace loyalty program at the consumer device 108.

The GUI screen 402 also includes a Pool Device button 412 that can be clicked by the consumer to pool another electronic device into the CloudSpace loyalty program.

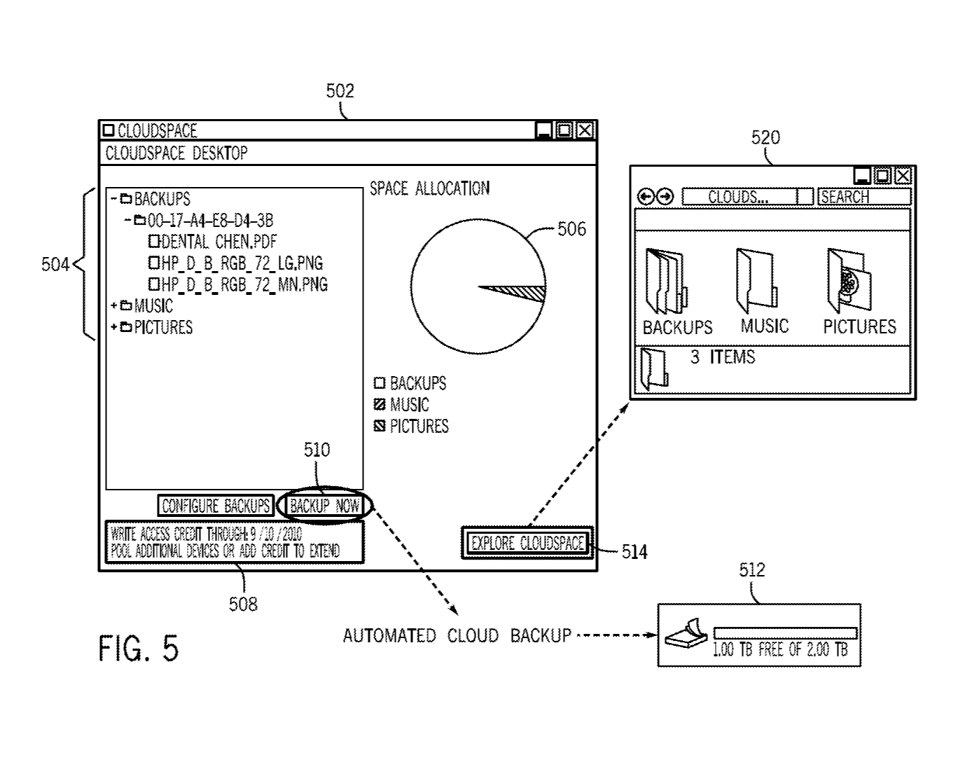

Upon clicking of the CloudSpace Desktop button 404 in FIG. 4, an example desktop GUI screen 502 as shown in FIG. 5 is displayed. The desktop GUI screen 502 shows various information 504 associated with content of the cloud storage space allocated to the consumer, as well as a pie chart 506 to indicate usage of the cloud storage space to store various different types of the consumer's data (e.g. backup data, music files, pictures).

Also, an indication 508 is provided to indicate how much time is available to the consumer for accessing cloud storage services. The indication 508 also states that certain activities can lead to increased cloud service credit (such as pooling additional devices or adding credit based on purchase of offerings).

Once a consumer has activated the CloudSpace loyalty program and is using the program, it can be assumed that the consumer appreciates the benefits provided by the program, particularly when the consumer purchases additional offerings or engages in other activities to extend the cloud service credit. This provides a “purchase to time” connection to allow the consumer an easy way to evaluate the value of the CloudSpace loyalty program associated with each activity of the consumer.

The desktop GUI screen 502 also includes a “Backup Now” button 510 to allow the consumer to access a premium cloud storage service, which in this case is a data backup service. Activating the “Backup Now” button 510 allows the consumer to back up certain consumer data to allocated storage space 512 (which is part of the storage system 102 of FIG. 1).

The desktop GUI screen 502 also includes an “Explore CloudSpace” button 514, which when clicked by the consumer causes an Explorer screen 520 to be displayed. The Explorer screen 520 allows the consumer to navigate through various folders that contain the consumer's data—these folders (and the data in these folders) are stored at the allocated storage space 512.

If the consumer purchases an additional electronic device that can use cloud storage services, the consumer can pool the additional electronic device with a first electronic device that is already registered with the consumer's CloudSpace loyalty program account. This allows the pooled electronic devices to share access to the cloud storage services. More than two electronic devices can be pooled together in this way.

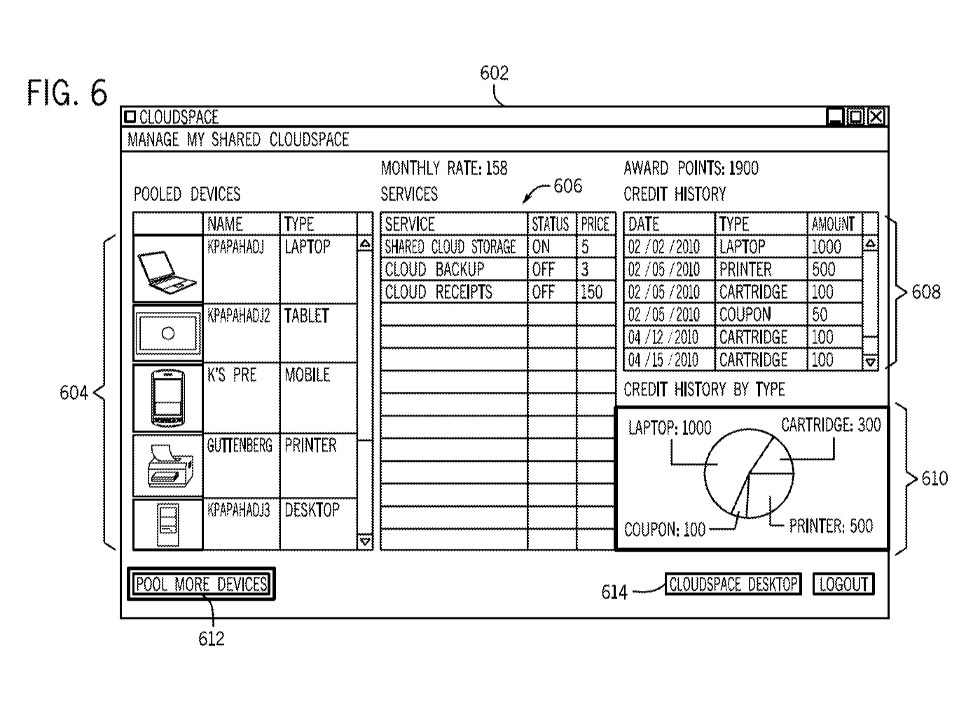

FIG. 6 shows another example GUI screen 602 that lists a number of pooled electronic devices 604 that are part of the same CloudSpace loyalty program account—in the example of FIG. 6, the pooled devices include a laptop computer, a tablet computer, a mobile device, a printer, and a desktop computer. In addition, various example cloud storage services 606 are listed, with associated “prices” also listed. The example cloud storage services 606 listed include a shared cloud storage service, a cloud backup service, and a cloud receipts service (expense report generation service). A consumer can thus easily determine how much of cloud service credit will be deducted for each of the listed cloud storage services.

Also, a credit history 608 associated with the depicted account can be displayed to allow the consumer to easily track events that have led to increased cloud service credit, and events relating to usage of cloud storage services that have led to reduced cloud service credit.

A pie chart 610 can also be displayed to allow the consumer to understand respective relative contributions of the pooled electronic devices (listed at 604) to the cloud service credits.

The GUI screen 602 also includes a Pool More Devices button 612 to allow the consumer to pool additional electronic devices. In addition, the GUI screen 602 includes a CloudSpace Desktop button 614 to allow the consumer to return to the CloudSpace desktop screen 502 of FIG. 5.

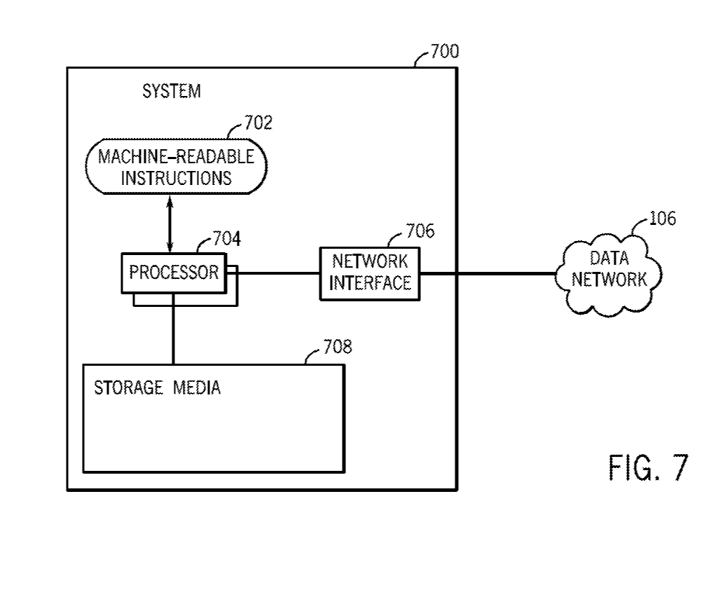

FIG. 7 illustrates an example system 700, which can be the consumer device 108 or the processing system 114 of FIG. 1. The system 700 includes machine-readable instructions 702 (e.g. loyalty program client module 110 or loyalty program management module 112 of FIG. 1) that are executable on one or multiple processors 704. A processor can include a microprocessor, microcontroller, processor module or subsystem, programmable integrated circuit, programmable gate array, or another control or computing device.

The processor(s) 704 is (are) connected to a network interface 706 and storage media 708. The network interface 706 allows the system 700 to communicate over the data network 106, whereas the storage media 708 can store data and machine-readable instructions.

The storage media 708 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method of a system having a processor, comprising:
receiving an indication of acquisition of an offering by a consumer;
determining, based on the acquisition of the offering, an amount of credit relating to a cloud storage service to award; and
enabling access of the cloud storage service by the consumer according to the awarded amount of credit, wherein the cloud storage service allows storage of data of the consumer at a storage system accessible over a network.

2. The method of claim 1, wherein receiving the indication of acquisition of the offering comprises receiving an indication of purchase of a product or service by the consumer.

3. The method of claim 1, wherein receiving the indication of acquisition of the offering comprises receiving an indication of activation of the cloud storage service by the consumer.

4. The method of claim 1, further comprising:
increasing the credit in response to receiving a further indication of purchase of another offering by the consumer; and
reducing the credit in response to usage of the cloud storage service.

5. The method of claim 1, further comprising:
associating an electronic device of the consumer with the cloud storage service, wherein the cloud storage service is accessible from the electronic device.

6. The method of claim 5, further comprising:
associating a second electronic device with the cloud storage service, wherein the cloud storage service is accessible from the second electronic device.

7. The method of claim 6, wherein the electronic devices are associated with different users.

8. The method of claim 1, wherein the cloud storage service is a basic cloud storage service to store data of the consumer, the method further comprising:
enabling access of a premium cloud storage service by the consumer according to the awarded amount of credit, wherein the premium cloud storage is in addition to the basic cloud storage service to store the data of the consumer.

9. The method of claim 1, further comprising:
tracking activity of the consumer related to the cloud storage service.

10. (canceled)

11. A system comprising:
a network interface to communicate over a network; and
at least one processor to:
present at least one user interface screen indicating available credit associated with usage of at least one cloud storage service available over the network, wherein the at least one cloud storage service allows storage of data of a user of the system accessible over the network, and wherein the credit is to be awarded in response to purchase of an offering by the user; and
access the at least one cloud storage service according to the credit.

12. The system of claim 11, wherein the at least one user interface screen includes an activation element that is activatable by the user, and wherein activation of the activation element causes activation of a consumer loyalty program that provides access to the at least one cloud storage service.

13. The system of claim 11, wherein the at least one user interface screen includes an element activatable by the user to pool plural electronic devices of the user to allow the pooled electronic devices to access the at least one cloud storage service.

14. A system comprising:
a network interface to communicate over a network; and
at least one processor to:
receive an indication of acquisition of an offering by a consumer;
determine, based on the acquisition of the offering, an amount of credit relating to a cloud storage service to award; and
enable access of the cloud storage service by the consumer according to the awarded amount of credit, wherein the cloud storage service allows storage of data of the consumer at a storage system accessible over the network.

15. The system of claim 14, wherein enabling access of the cloud storage service comprises providing an indication from the system to a remote storage system indicating that credit relating to the cloud storage service is available.
